(19) United States
(12) Patent Application Publication
(10) Pub. No.: US 2013/0097252 A1
(43) Pub. Date: Apr. 18, 2013

(54) SYSTEM, METHOD AND COMPUTER PROGRAM PRODUCT FOR AUTOMATICALLY CREATING AN OBJECT FROM AN ELECTRONIC MESSAGE IN RESPONSE TO USER INPUT

(71) Applicants: Blake Whitlow Markham, San Francisco, CA (US); Ken Wakamatsu, San Francisco, CA (US)

(72) Inventors: Blake Whitlow Markham, San Francisco, CA (US); Ken Wakamatsu, San Francisco, CA (US)

(73) Assignee: salesforce.com, inc., San Francisco, CA (US)

(21) Appl. No.: 13/490,390

(22) Filed: Jun. 6, 2012

Related U.S. Application Data
(60) Provisional application No. 61/546,131, filed on Oct. 12, 2011.

(51) Int. Cl. G06F 15/16

(52) U.S. Cl. 709/206

(57) ABSTRACT

In accordance with embodiments, there are provided mechanisms and methods for creating an object from an electronic message in response to user input. These mechanisms and methods for creating an object from an electronic message in response to user input can enable an automated technique for users to create an object from an electronic message. The ability to provide automated creation of objects from electronic messages may allow users to avoid manually creating an object storing information associated with an electronic message.

### CLAIM OF PRIORITY

This application claims the benefit of U.S. Provisional Patent Application 61/546,131 entitled “Systems and Methods for Creating a Case from an Email Client,” by Markham et al., filed Oct. 12, 2011 (Attorney Docket No, SFC1P182+/785PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to automatic creation of data objects.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

There are various different situations where a person receiving an electronic message may desire to store information associated with the electronic message in a location, format, etc. that is separate from the electronic message. Just by way of example, a person receiving an electronic message pertaining to an issue may desire to store information relating to a task needing to be performed to resolve the issue. Unfortunately, conventional applications associated with electronic messages have been limited to the management of the electronic message itself, and have generally been incapable of automating for users the ability to create an object from an electronic message.

Accordingly, it is desirable to provide techniques enabling the automatic creation of objects from electronic messages to improve functionality associated with electronic messaging systems.

### BRIEF SUMMARY

In accordance with embodiments, there are provided mechanisms and methods for automatically creating an object from an electronic message in response to user input. These mechanisms and methods for automatically creating an object from an electronic message in response to user input can enable embodiments to provide an automated technique for users to create an object from an electronic message. The ability of embodiments to provide automated creation of objects from electronic messages may allow users to avoid manually creating an object storing information associated with an electronic message.

In an embodiment and by way of example, a method for automatically creating an object from an electronic message in response to user input is provided. In use, a first selection by a user of an electronic message is received. Additionally, a second selection by the user of an option to create an object from the electronic message is received. Further, the object is automatically created from the electronic message, in response to the second selection.

While one or more implementations and techniques are described with reference to an embodiment in which automatically creating an object from an electronic message in response to user input is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for automatically creating an object from an electronic message in response to user input, in accordance with an embodiment;

FIG. 2 illustrates a method for configuring an email client to enable the automatic creation of objects from emails, in accordance with an embodiment;

FIG. 3 illustrates a method for receiving a user request to create an object from an email, in accordance with an embodiment;

FIG. 4 illustrates a method for automatically creating an object from an email in response to a user request, in accordance with an embodiment;

FIGS. 5A-5C are graphical user interfaces for use in automatically creating an object from an electronic message in response to user input, in accordance with an embodiment;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for automatically creating an object from an electronic message in response to user input.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing automatically creating an object from an electronic message in response to user input will be described with reference to example embodiments.

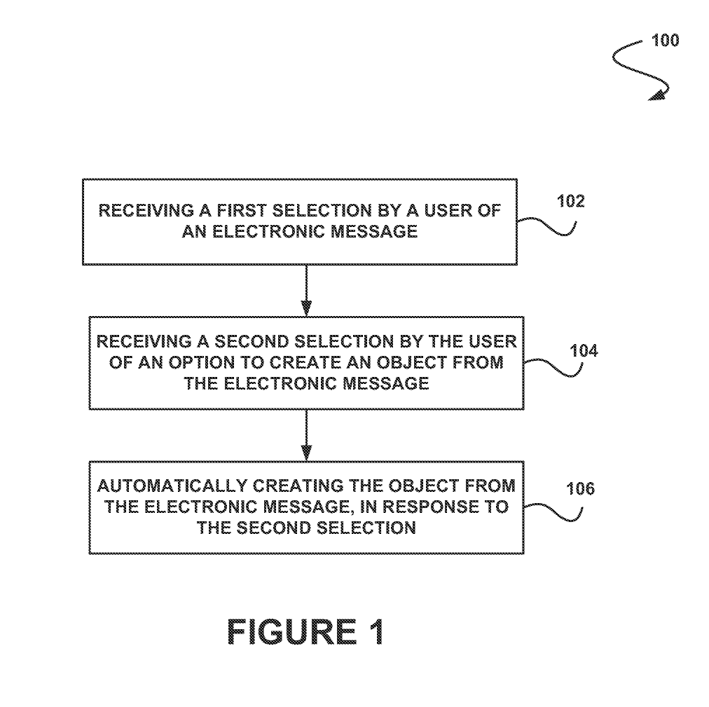

FIG. 1 illustrates a method 100 for automatically creating an object from an electronic message in response to user input, in accordance with an embodiment. As shown in operation 102, a first selection by a user of an electronic message is received. In the context of the present description, the electronic message may be any message capable of being electronically transmitted with respect to at least one computing device. For example, the electronic message may be an email message, short message service (SMS) message, etc.

In one embodiment, the user by which the first selection of the electronic message is made may be a user that received, sent, created, etc. the electronic message. Of course, however, the user may be any person having access to the electronic message by a device of the user. In another embodiment, the first selection may be made by the user using an interface of an electronic message client (e.g. email application, etc.), which may be located on the device of the user. Such first selection may be the user highlighting the electronic message in a list of electronic messages, opening the electronic message, etc.

Additionally, as shown in operation 104, a second selection by the user of an option to create an object from the electronic message is received. Such second selection may also be made by the user using the interface of the electronic message client. For example, the second selection may include a user clicking the option (e.g. icon) in the interface of the electronic message client. As a further option, the second selection, and similarly the first selection, may be received by an on-demand database service.

In one embodiment, the first selection and the second selection may be received by the on-demand database service in the form of a package including the electronic message. For example, in response to the user making the first selection and the second selection (e.g. via the electronic message client interface), the device of the user may notify the on-demand database service of the selections by sending the package including the electronic message to the on-demand database service. In other embodiments, the package received by the on-demand database service from the device of the user may not necessarily include an entirety of the electronic message, but instead may optionally include portions thereof, such as predetermined portions of the electronic message.

Further, as shown in operation 106, the object is automatically created from the electronic message, in response to the second selection. In this way, the first selection of the electronic message and the second selection of the option may prompt the automatic creation of the object from the electronic message. In one embodiment, the object may be automatically created by the on-demand database service.

In the present description, the object may be any data structure capable of storing data from the electronic message. For example, the object may be a record in a table. The record may have various fields for storing the data from the electronic message.

Optionally, the object may be of a predetermined type. The predetermined type may be a predefined structure for the object. Just by way of example, where the object is a record, the record may have predetermined fields for storing the data from the electronic message.

As noted above, the object stored data from the electronic message. This may include the object storing information retrieved from at least one predetermined portion of the electronic message. In one embodiment, the predetermined portion of the electronic message may be attachments to the electronic message, such that the information stored in the object may include the attachments. In another embodiment, the predetermined portion of the electronic message may be a particular header of the electronic message, such that the information stored in the object may include data stored in the particular header (e.g. an identifier of a receiver of the electronic message, etc.).

By automatically creating the object from the electronic message in response to the first selection and the second selection, the user may prompt the automatic creation of the object having the data from the electronic message. This may prevent the user from having to manually enter the data from the electronic message into the object.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

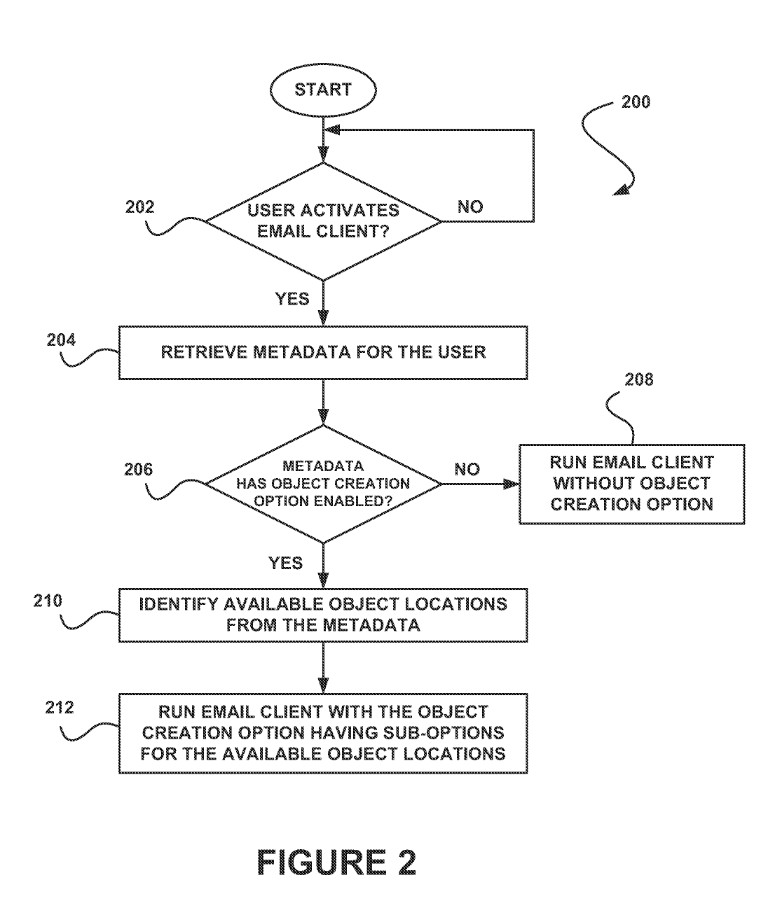

FIG. 2 illustrates a method 200 for configuring an email client to enable the automatic creation of objects from emails, in accordance with an embodiment. As an option, the method 200 may be carried out in the context of the method 100 of FIG. 1. Of course, however, the method 200 may be carried out in any desired environment. It should also be noted that the aforementioned definitions may apply during the present description.

As shown in decision 202, it is determined whether a user activates an email client. The user may activate the email client by selecting an option to run or otherwise open the email client on a device of the user. If it is determined that the user does not activate the email client, the method 200 continues to wait for the user to activate the email client.

However, once it is determined that the user activates the email client, metadata for the user is retrieved. Note operation 204. The metadata may be retrieved from an on-demand database service, in one embodiment. Thus, the metadata may optionally be retrieved by remotely querying the on-demand database service for the metadata.

In the present embodiment, the metadata may be any data describing a configuration associated with the email client. For example, the metadata may indicate whether an object creation option is enabled in the email client for the user, namely whether the email client for the user is configured to allow the automatic creation of objects from emails. As another example, the metadata may indicate available locations for storing any objects automatically created from the emails.

It is then determined in decision 206 whether the metadata has the object creation option enabled. If it is determined that the object creation option is not enabled, the email client is run without the object creation option, as shown in operation 208. In this way, the user may be prevented from using the email client to automatically create objects from emails.

If it is determined that the object creation option is enabled, available object locations are identified from the metadata. Note operation 210. As noted above, the available object locations may be locations that are available to the user for storing objects automatically created from the emails. Accordingly, the available object locations may be based on permissions of the user, namely by including only locations that the user is permitted to access. Each location may optionally be associated with a different organization (e.g. tenant), team, user, etc. in the on-demand database service.

Furthermore, as shown in operation 212, the email client is run with the object creation option having sub-options for the available object locations. In this way, the user may interact with the email client to select an email listed therein, and to further select the object creation option including one of the sub-options for automatically creating an object from the selected email and storing the object in the location indicated by the selected sub-option.

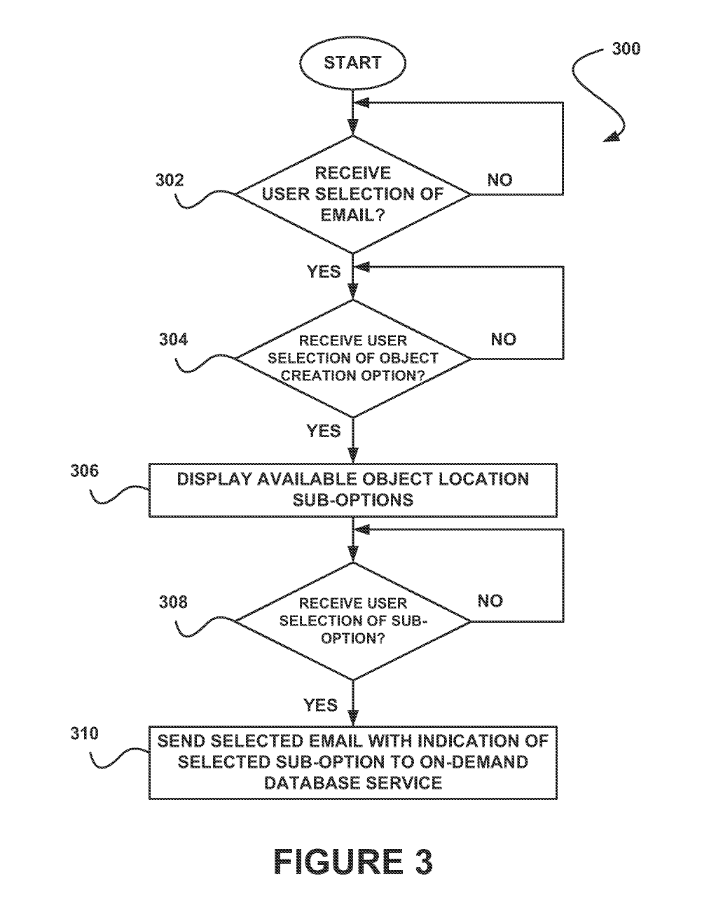

FIG. 3 illustrates a method 300 for receiving a user request to create an object from an email, in accordance with an embodiment. As an option, the method 300 may be carried out in the context and environment of FIGS. 1-2. For example, the method 300 may be carried out by the email client configured in accordance with the method 200 of FIG. 2. Of course, however, the method 300 may be carried out in any desired environment. It should also be noted that the aforementioned definitions may apply during the present description.

As shown in decision 302, it is determined whether a user selection of an email is received. The email may be one of a plurality of emails listed in an interface of an email client. The email may further be one that has been received, sent, created, etc. by the user, for example.

If a user selection of an email is not received, the method 300 continues to wait for the user to select an email. Once, however, a user selection of an email is received, it is determined in decision 304 whether a user selection of an object creation option is received. If is it determined that a user selection of an object creation option is not received, the method 300 continues to wait for such a selection.

In response to a user selection of an object creation option (e.g. via the interface of the email client), available location sub-options are displayed to the user. Note operation 306. The available object location sub-options may indicate different object locations in which an object automatically created from the email may be stored. Optionally, the object location sub-options may only be available (and thus displayed) in response to a determination that the user is permitted access to the same.

In this way, the object creation option selected by the user may have a plurality of sub-options, such that a selection by the user to automatically create an object from the selected email may include selection of one of the sub-options. Of course, where only one object location is available, the user selection of the object creation option may automatically indicate the available location for storing the object.

Moreover, it is determined in decision 308 whether a user selection of one of the sub-options is received. If it is determined that a user selection of one of the sub-options is not received, the method 300 continues to wait for the user to select one of the sub-options. Once it is determined that a user selection of one of the sub-options is received, the selected email is sent to an on-demand database service with an indication of the selected sub-option. Note operation 310. The selected email and indication of the sub-option may be sent to the on-demand database service via any desired transport protocol. Thus, the selected email, etc. may not necessarily be sent to the on-demand database service via an email protocol, such that the selected email, etc. may be received by an application programming interface (API) of the on-demand database service that is not necessarily associated with an email client or server of the on-demand database service.

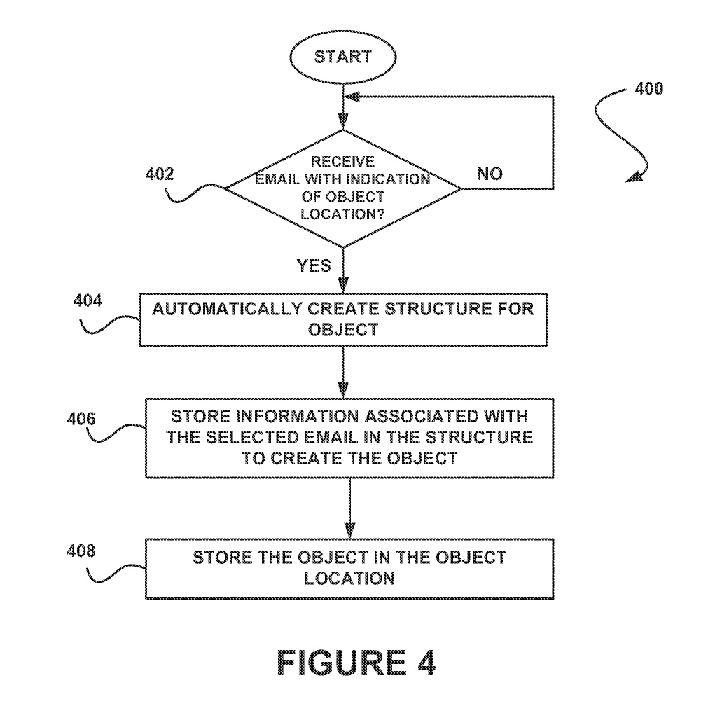

FIG. 4 illustrates a method 400 for automatically creating an object from an email in response to a user request, in accordance with an embodiment. As an option, the method 400 may be carried out in the context and environment of FIGS. 1-3. For example, the method 400 may be carried out by the on-demand database service in response to the method 300 of FIG. 3. Of course, however, the method 400 may be carried out in any desired environment. It should also be noted that the aforementioned definitions may apply during the present description.

As shown in decision 402, it is determined whether an email with an indication of an object location is received. In one embodiment, the email may be received in response to a user selecting to automatically create an object from the email. Thus, the email may be received for the purpose of automatically creating an object from the email. If it is determined that an email is not received, the method 400 continues to wait for receipt of an email.

Once it is determined that an email is received, a structure for holding an object is automatically created. Note operation 404. The structure may be a record with one or more fields (e.g. of predetermined number, type, etc.). Further, information associated with the email is stored in the structure to create the object. Note operation 406. The information may be retrieved from predetermined portions of the email. For example, each predetermined portion of the email e.g. attachments, header, etc.) may be mapped to one of the fields of the object, such that the information included in each predetermined portion of the email may be stored in the field of the object that is mapped to such predetermined portion of the email.

Still yet, as shown in operation 408, the object is stored in the object location. In this way, the object may be accessible at the object location for various purposes. For example, the object may be accessible for viewing, modifying, etc. the same.

In one exemplary embodiment, a user may select an email in an email client and may further select an option to create a case record from the selected email for potential sales or other record keeping. The case record may then be automatically created by including information in the case record from the selected email.

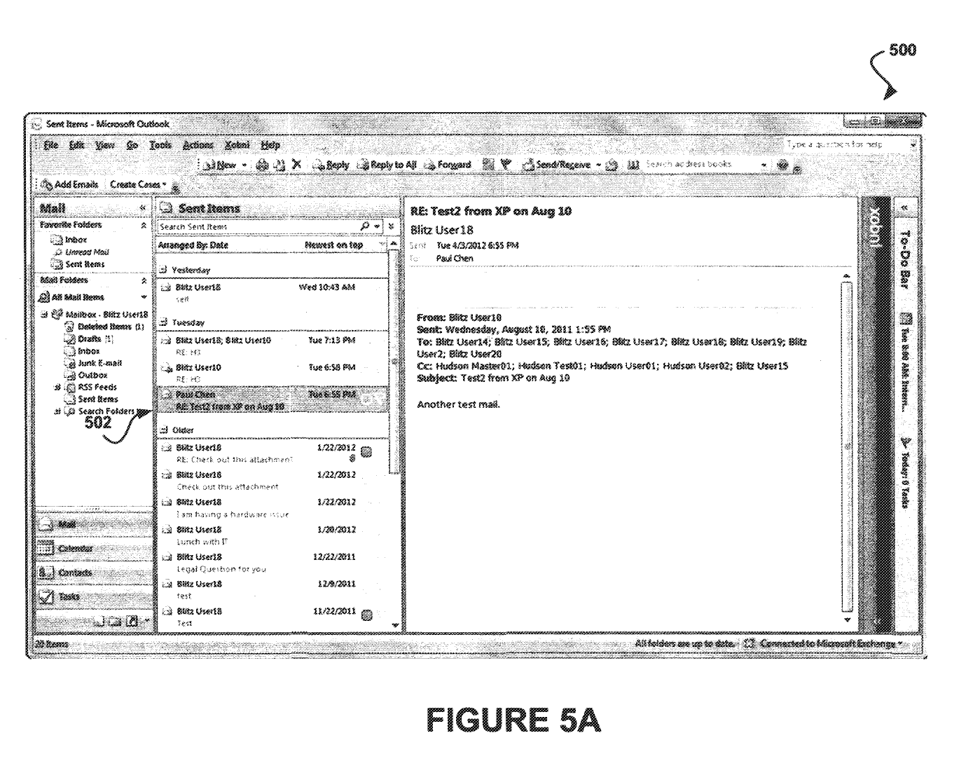

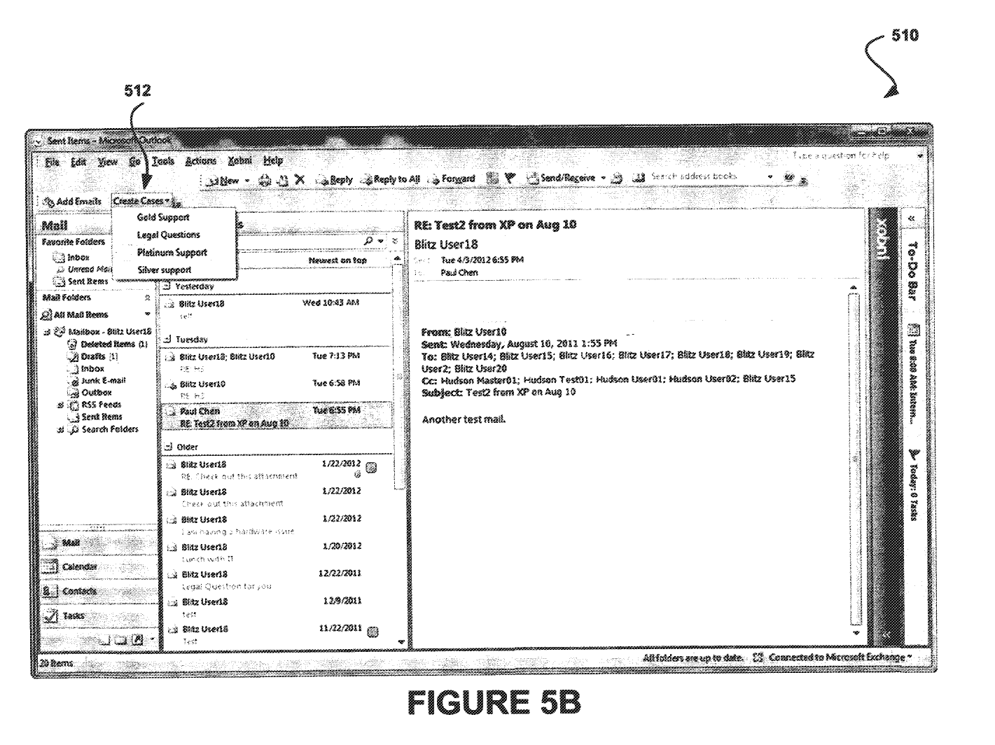

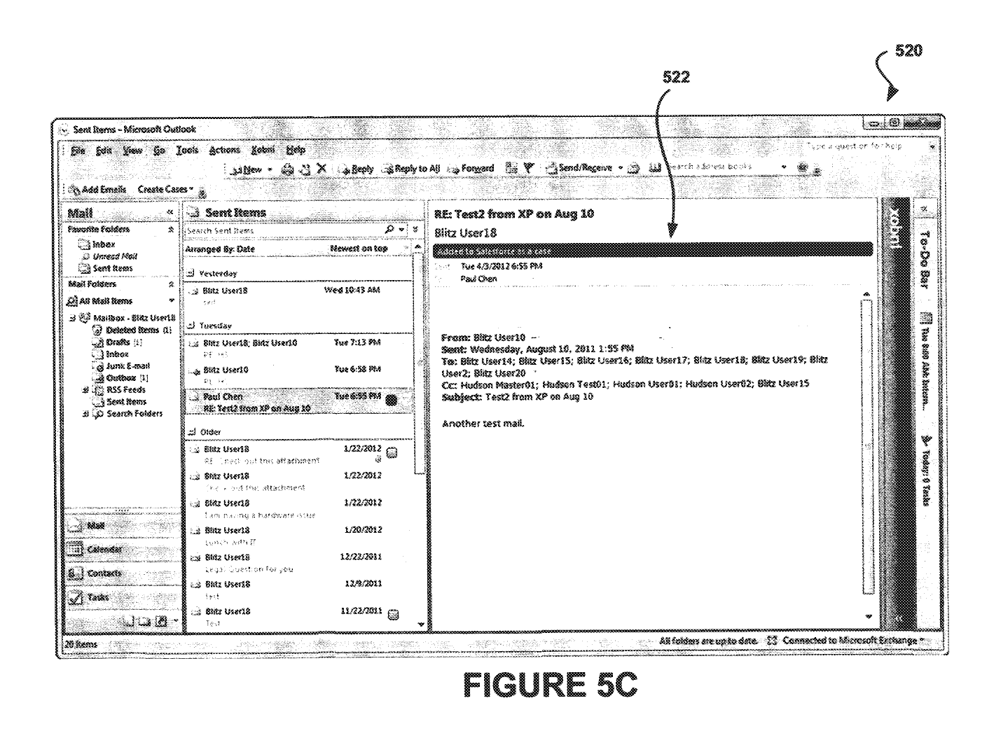

FIGS. 5A-5C are graphical user interfaces (GUIs) 500-520 for use in automatically creating an object from an electronic message in response to user input, in accordance with an embodiment; As an option, the GUIs 500-520 may be implemented in the context and environment of FIGS. 1-4. Of course, however, the GUIs 500-520 may be implemented in any desired environment. It should also be noted that the aforementioned definitions may apply during the present description.

As shown in the GUI 500 of FIG. 5A, an interface of an email client displays a plurality of emails associated with a user. The emails may be those that have been received, sent, created (and stored as a draft), etc, by the user. Further, one of the emails 502 is selected by the user.

As shown in the GUI 502 of FIG. 5B, an object creation option 512 is included in the interface of the email client. The object creation option 512 includes a plurality of sub-options each indicative of a different location in which an object created from an email by the user may be stored. In response to selection of the object creation option 512, the sub-options are displayed.

Once the object creation option 512, including one of the sub-options, is selected by the user, an object is automatically created from the email, as shown in the GUI 520 of FIG. 5C. In FIG. 5C, the interface of the email client is configured to display a notification 522 for each email from which an object has been automatically created. The notification indicates that the object has been automatically created from the email, based on the user selection of the object creation option 512 as described above.

### System Overview

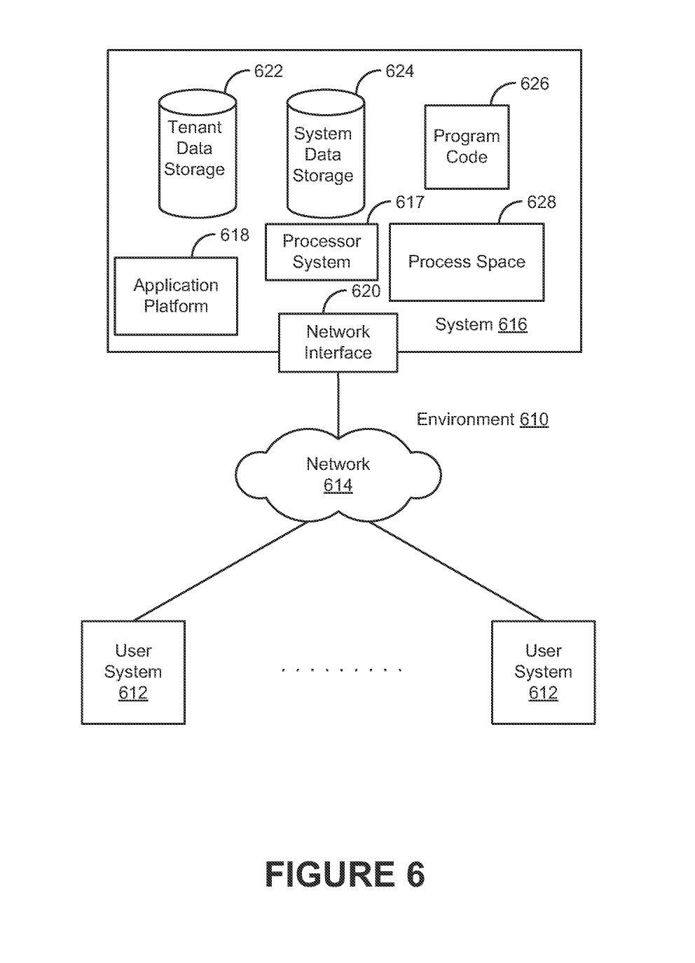

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

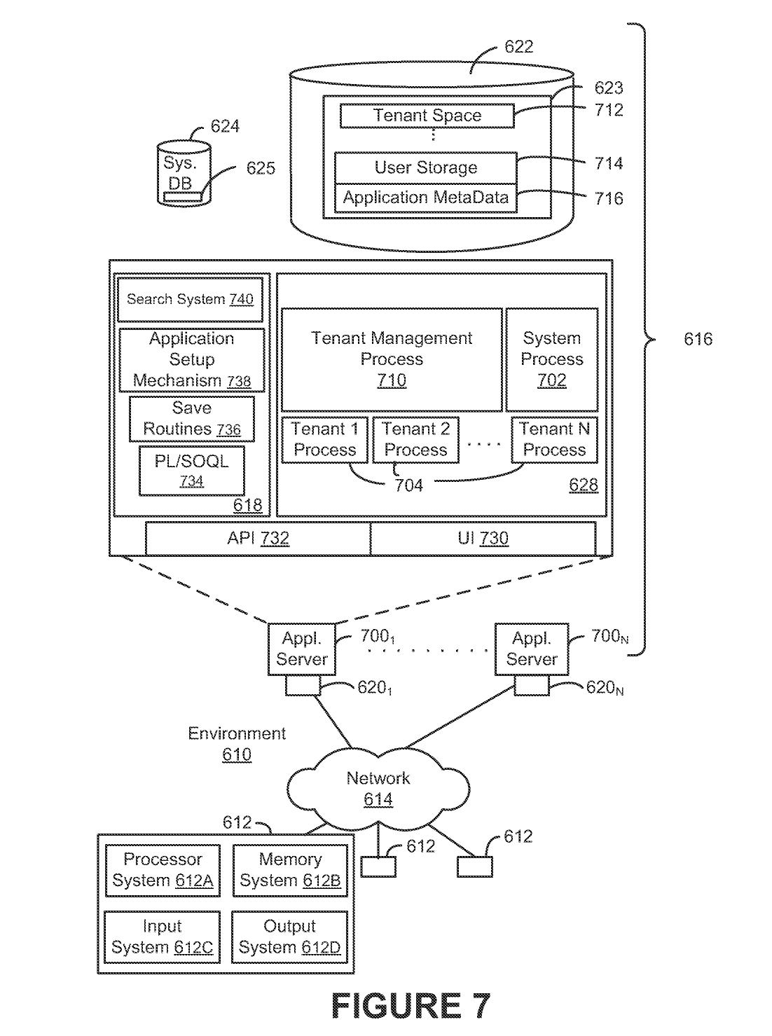

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower, permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used, (Java™ is a trademark of Sun Microsystems, (Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 61213 may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user, For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 516 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-4} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700, Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant, Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be c lent systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method, the method comprising:
receiving a first selection of an electronic message by a user;
receiving a second selection by the user of an option to create an object from the electronic message; and
automatically creating the object from the electronic message, in response to the second selection.

2. The computer program product of claim 1, wherein the first selection and the second selection are made by the user using an interface of an electronic message client.

3. The computer program product of claim 2, wherein the electronic message client is located on a device of the user.

4. The computer program product of claim 1, wherein the first selection and the second selection are received by an on-demand database service.

5. The computer program product of claim 4, wherein the first selection and the second selection are received by the on-demand database service in the form of a package including the electronic message.

6. The computer program product of claim 4, therein the object is automatically created by the on-demand database service.

7. The computer program product of claim 1 therein the object is a record in a table.

8. The computer program product of claim 1, wherein the object is of a predetermined type.

9. The computer program product of claim 1, wherein the object stores information retrieved from at least one predetermined portion of the electronic message.

10. The computer program product of claim 9, wherein the at least one predetermined portion includes attachments to the electronic message.

11. The computer program product of claim 10, wherein the information stored in the object includes the attachments.

12. The computer program product of claim 9, wherein the at least one predetermined portion includes a header of the electronic message.

13. The computer program product of claim 12, wherein the information stored in the object includes an identifier of a receiver of the electronic message.

14. The computer program product of claim 1, wherein the option selected second by the user indicates an available location for storing the object.

15. The computer program product of claim 14, further comprising storing the object in the available location.

16. The computer program product of claim 1, wherein the option selected second by the user has a plurality of sub-options, such that the second selection by the user includes selection of one of the sub-options.

17. The computer program product of claim 16, wherein each of the sub-options is indicative of a different available location for storing the object.

18. The computer program product of claim 17, wherein the available locations for storing the object are determined based on permissions of the user.

19. A method, comprising:
receiving a first selection of an electronic message by a user;
receiving a second selection by the user of an option to create an object from the electronic message; and
automatically creating the object from the electronic message, in response to the second selection.

20. An apparatus, comprising:
a processor for:
receiving a first selection of an electronic message by a user;
receiving a second selection by the user of an option to create an object from the electronic message; and
automatically creating the object from the electronic message, in response to the second selection.

21. A method for transmitting code, comprising:
transmitting code for receiving a first selection of an electronic message by a user;
transmitting code for receiving a second selection by the user of an option to create an object from the electronic message; and
transmitting code for automatically creating the object from the electronic message, in response to the second selection.
